(19) United States
(12) Patent Application Publication
(10) Pub. No.: US 2012/0000112 A1
(43) Pub. Date: Jan. 5, 2012

(54) Flexible shaft spinnerbait fishing lure assembly with"V" shaped stabilizer

(76) Inventor: Robert William Osler, Brossard (CA)

(21) Appl. No.: 12/830,400

(22) Filed: Jul. 5, 2010

(51) Int. Cl. A01K 85/00

(52) U.S. Cl. 43/42.19; 43/42.39

(57) ABSTRACT

A flexible shaft spinnerbait fishing lure assembly comprising a main flexible shaft of a minimum diameter of 0.041 inch onto which is incorporated, along its length, a rigid or semi rigid “V” shape stabilizer, onto which is integrated an eyelet onto which the fishing line is attached, and which serves to maintain the “V” shape of the spinnerbait assembly, resulting in little to no deformation or breakage of the assembly with continued use. The preferred positioning of the stabilizer and its preferred fish attracting head shape weight, hook and fish attracting components configurations allow for increased overall stability of the assembly, including vertical stability when being pulled through water. Due to this increased stability, the flexible spinnerbait assembly also generates, with greater consistency, the frequencies desired to increase fish attraction.

### BACKGROUND OF THE INVENTION

1. Field of the Invention

This invention relates to fishing lures, specifically to what are commonly called spinnerbaits.

2. Description of the Prior Art

Prior art related to various fishing lures, some of which may be relevant to the present invention, are disclosed in U.S. Pat. No. 4,201,008 to Sparkman which discloses a plurality of conventional spinners. In addition, U.S. Pat. No. 4,209,932 to Pate as well as U.S. Pat. No. 4,773,180 to Shimizu discloses spinner lures with plural blades. U.S. Pat. No. 5,024,019 to Rust discloses a fishing lure with a blade and a sound generating rattle. U.S. Pat. No. 4,011,681 to Johnson discloses a fishing lure with a blade and a spring element in one portion of the support rod (main shaft) for increased flexibility. U.S. Pat. No. 5,647,163 to Gorney discloses a spinner lure with a stainless wire main shaft.

| | | | |
|---|---|---|---|
| 520178 | Spinnerbait fishing lure | April, 1993 | Mcwilliams |
| 666597 | Spinnerbait fishing lure | November 2001 | Hammond |
| 540054 | Fishing lure system with | October 1993 | Johnson |
| | flexible support rod | | |
| 514670 | Weedless fishing lure | September 1992 | Hilliard |
| | apparatus | | |
| 5,113,606 | Scented lure | May 1992 | Rinker |
| 481523 | Fish lure | March 1989 | Pingel |
| 480533 | Sonic fishing lure | February 1989 | Fuentes |
| 464004 | Spinner bait with arms | February 1987 | Stanley |
| | of different diameter | | |
| 457187 | Fishing lure | February 1986 | Montgomery |
| 420993 | Spinner bait fishing lure | June 1978 | Pate |
| 420100 | Fishing lure and spinner | January 1979 | Sparkman |
| 502401 | Spinner bait lure with | June 1989 | Rust |
| | rattle pod | | |
| 4,011,681 | Fishing lure | October 1975 | Johnson |

Fishing lures, including “V” shape fishing lure assemblies such as spinnerbaits, are known in the prior art. However, most spinnerbaits which are found in prior art and in industry today embody shafts or shanks (arms) made of relatively rigid material (such as stainless steel wire), which is less flexible than the type of main shaft used in the present invention (flexible shaft), and which can become deformed or break after continued use, thus adversely affecting the overall desired performance of the lure assembly.

Of all the above-mentioned patented inventions, two patents with flexible support rods, relevant to the present invention, have been submitted (U.S. Pat. No. 5,400,542 to Johnson and U.S. Pat. No. 6,665,977 to Hammond). They, however, are substantially different in their concepts or designs or results.

U.S. Pat. No. 5,400,542 to Johnson (Fishing lure system with flexible support rod) differs in its concept, in its design (“U” shape configuration) and in its results as it does not incorporate a “V” shape stabilizer for maintaining the desired “V” shape configuration (versus a “U” shape) as in the present invention. The diameter of the main flexible shaft may also be smaller than that which is embodied in the present invention and may thus cause distortion of the shanks of the “U” shape configuration of the assembly and lead to instability and malfunction of the entire assembly when pulled through water.

U.S. Pat. No. 6,665,977 to Hammond (Spinnerbait fishing lure) differs in its concept, in its design (a straight flexible shaft configuration intended to bend when pulled through water) and in its results as it does not incorporate a “V” shape stabilizer for maintaining the desired “V” shape configuration, as in the present invention, and, due to its concept and design, may lead to instability of the entire assembly when pulled through water.

### SUMMARY OF THE INVENTION

This invention, which relates to fishing lures in general, specifically to what are commonly called spinnerbaits, and more specifically to flexible spinnerbait assemblies, is a spinnerbait assembly with a main flexible shaft onto which is incorporated, along its length, a rigid or semi rigid “V” shape stabilizer which 1) assures the assembly maintains the desired “V” shape and 2) allows for attachment of the fishing line to the lure. The present invention embodies two designs for the “V” shape stabilizer, both of which accomplish the same task, with essentially the same results, and can be used interchangeably for the assembly. Compared to existing spinnerbaits, the present invention maintains the desired “V” shape in its relaxed state as well as when pulled through water and is thus more stable and thus more efficient. The main flexible shaft may be of diameters greater than or equal to 0.041 inch and may be made of any material or combination of materials (such as flexible nylon coated stainless steel wire) which allows for the desired flexibility. The “V” shape stabilizer may be made of any material or combination of materials which allows for the desired rigidity necessary to maintain the “V” shape of the assembly, and, depending on the desired overall configuration of the assembly, the “V” shape stabilizer can be of different lengths and can be incorporated anywhere along the length of the main flexible shaft, thus allowing for different lengths of the two shanks comprising the “V” shape. Generally, to one extremity of the main flexible shaft, or along its corresponding shank, is incorporated a fish attracting head shape weight with 2-D or 3-D eyes, coupled with a hook or hooks, and hook skirt or Buck Tail, and in some cases, additional fish attracting components such as an artificial bumble bee. To the other extremity of the main flexible shaft and along its corresponding shank, are incorporated combinations of beads, clevises, blades, jingle bells and a single or double barrel sleeve which forms a loop to hold a crane swivel, barrel swivel or ball bearing swivel on which is attached a blade or blades. The aforementioned components of the assembly can be of various arrangements, shapes, sizes, lengths and materials which can be color coordinated in a manner most effective for catching a particular species of fish in a given fishing situation.

Compared to flexible spinnerbait assemblies which currently exist on the market and in prior art, the main innovations of the present flexible spinnerbait assembly, are 1) the diameter of the main flexible shaft, which is larger than that used in, for example, the flexible lure embodied in U.S. Pat. No. 5,400,542, and 2) the newly invented “V” shape stabilizer, which has not been seen in prior art or on the market. Both innovations, in combination, enable the spinnerbait assembly to more effectively maintain its desired “V” shape configuration when pulled through water (versus U.S. Pat. No. 6,665,977, for example) and provides the assembly with greater overall stability. When the assembly is pulled through water, the “V” shape angle is reduced depending on the retrieve speed of the angler and the pressure caused by the water against the lure, but it still holds its “V” shape configuration. When slack is provided to the fishing line, the lure assumes a wider “V” shape configuration, and when the spinnerbait assembly is in its relaxed position, it assumes its initial wider “V” shape configuration. The “V” shape stabilizer, which maintains the assembly's “V” shape while being pulled through water, also assures that the two shanks and the corresponding assembly components do not become entangled while in use. Compared to spinnerbaits with rigid shafts, the higher flexibility of the main flexible shaft of the present invention helps to reduce the risk of undesired distortion or breakage of the shanks with increased use, thus allowing for longer lasting overall stability and desired performance of the assembly, which in turn produces steadier and smoother natural vibrations which are commonly known to attract fish. The preferred positioning of the components, in combination with the main flexible shaft and the “V” shape stabilizer also provide increased vertical stability of the assembly when pulled through water.

### BRIEF DESCRIPTION OF THE DRAWINGS

FIG. 1 is a side view depicting the preferred assembly and configuration of the main parts (skeleton) comprising the flexible shaft spinnerbait assembly, showing each of the two preferred designs of the “V” shape stabilizer.

FIG. 2 is a side view depicting the preferred assembly and configuration of the main parts (skeleton) of the flexible shaft spinnerbait assembly, showing one of the two preferred designs of the “V” shape stabilizer and comprising the basic preferred fish attracting head shape weight with integrated hook and eyelet configuration.

FIG. 3 is a side view depicting the preferred assembly and configuration of the main parts (skeleton) of the flexible shaft spinnerbait assembly, showing one of the two preferred designs of the “V” shape stabilizer and comprising the basic preferred fish attracting head shape weight with integrated hook and eyelet configuration and the preferred arrangement of basic fish-attracting components.

FIG. 4 is a side view depicting the preferred assembly and configuration of the main parts (skeleton) of the flexible shaft spinnerbait assembly, showing one of the two preferred designs of the “V” shape stabilizer and comprising the basic preferred fish attracting head shape weight with integrated hook and eyelet configuration, the preferred arrangement of basic fish-attracting components and additional fish-attracting components and a trailer hook.

FIG. 5 is a side view depicting the preferred assembly and configuration of the main parts (skeleton) of the flexible shaft spinnerbait assembly, showing one of the two preferred designs of the “V” shape stabilizer and comprising the basic preferred fish attracting head shape weight with integrated hook and eyelet configuration, the preferred arrangement of basic fish-attracting components and a trailer hook with a hook skirt.

FIG. 6 is a side view depicting the preferred assembly and configuration of the main parts (skeleton) of the flexible shaft spinnerbait assembly, showing one of the two preferred designs of the “V” shape stabilizer and comprising the basic preferred fish attracting head shape weight with integrated hook and eyelet configuration, the preferred arrangement of basic fish-attracting components and a trailer hook, as well as Buck Tail.

FIG. 7 is a side view depicting the preferred assembly and configuration of the main parts (skeleton) of the flexible shaft spinnerbait assembly, showing one of the two preferred designs of the “V” shape stabilizer and comprising the basic preferred fish attracting head shape weight with integrated hook and eyelet configuration, the preferred arrangement of basic fish-attracting components and a bumble bee assembly.

FIG. 8 is a side view depicting the preferred assembly and configuration of the main parts (skeleton) of the flexible shaft spinnerbait assembly, showing one of the two preferred designs of the “V” shape stabilizer and comprising the preferred arrangement of basic fish-attracting components, but with a variation of the method by which the fish attracting head shape weight with integrated hook is attached to the main assembly.

FIG. 9 is a side view depicting the preferred assembly and configuration of the main parts (skeleton) of the flexible shaft spinnerbait assembly, showing one of the two preferred designs of the “V” shape stabilizer and comprising the preferred arrangement of basic fish-attracting components, but with yet another variation of the method by which the fish attracting head shape weight with integrated hook is attached to the main assembly.

FIG. 10 is a side view depicting the preferred assembly and configuration of the main parts (skeleton) of the flexible shaft spinnerbait assembly, showing one of the two preferred designs of the “V” shape stabilizer and comprising the preferred arrangement of basic fish-attracting components, but with the fish attracting head shape weight incorporated directly onto the main shaft of the assembly and the hook separately attached to the end of main shaft.

FIG. 11 is a side view depicting the preferred assembly and configuration of the main parts (skeleton) of the flexible shaft spinnerbait assembly, showing one of the two preferred designs of the “V” shape stabilizer and comprising the preferred arrangement of basic fish-attracting components, but with the fish attracting head shape weight attached to the end of main shaft and the hook attached to the fish attracting head shape weight in the fashion depicted.

### DETAILED DESCRIPTION OF THE INVENTION

Its functional advantages:

This Flexible Shaft Spinnerbait Fishing Lure Assembly With “V” Shape Stabilizer is unlike other conventional spinner baits, generally maintaining its intended “V” shape configuration and remaining in a vertical position while being pulled through water, with its weighted side remaining generally downward and the main fish attracting blade components at the opposite extremity of the weighted side remaining generally upward while being pulled through water while both shanks of the main flexible shaft move up and down depending on the speed with which the assembly is being pulled through the water. The faster the assembly is retrieved through water the more compact it becomes, yet it maintains its “V” shape configuration and the assembly remains vertical without rolling from side to side (laterally). When being pulled through water slowly, the assembly retains a wider “V” shaped configuration and still remains vertical without rolling from side to side.

This spinnerbait fishing lure produces more desirous fish attracting vibrations, much more so than the standard “hard” wire spinnerbaits made of stainless steel or other rigid or semi rigid metals. This is mainly due to the fact that both shanks of the Flexible Shaft Spinnerbait Fishing Lure Assembly With “V” Shape Stabilizer are highly flexible, thus more effectively interacting with the natural surrounding forces, thus generating more natural vibrations. Such natural vibrations are known to attract fish.

As with most types of lures, when a fish is initially attracted to a spinnerbait assembly, it often bumps into it seeking out the bait. When a fish bumps into a standard “hard” wire spinnerbait assembly seeking the bait, it must move against the entire rigid “V Shape Frame” of the assembly to seek the bait in order to eventually get properly hooked. With the two flexible shanks of the main flexible shaft of the present invention, which are held in position with the “V” shape stabilizer, the spinnerbait arms are free to easily move laterally, up and down, and generally in any direction, thus, when the fish initially bumps into the assembly seeking the bait, it encounters less resistance and becomes more easily hooked. When a fish gets hooked to a lure, it will often jump to try to get rid of it. Generally, standard “hard” wire spinnerbait assemblies are formed from one piece of solid rigid wire which is bent into a “V shape frame” making the assembly relatively inflexible and thus making it easier for the fish to shake it off due to its inflexibility. With the present invention and its innovative flexible, yet stable, design, when a hooked fish jumps, the fish has a very difficult time shaking it off. What is noticed when using the present invention is that most fish will hook themselves just by bumping into it and will stay hooked ⅘ or 9/10 times.

Unlike the relatively few flexible spinnerbaits fishing lures which exist on the market, this present invention, due to its incorporated “V” shape stabilizer and its overall preferred configuration, permits the assembly to maintain its “V” shape configuration, with the two flexible shanks of the main flexible shaft also free to swing about in many directions, while keeping both shanks with their corresponding integrated or attached components at appropriate distances away from each other such that self entanglement of the shanks and their components is avoided.

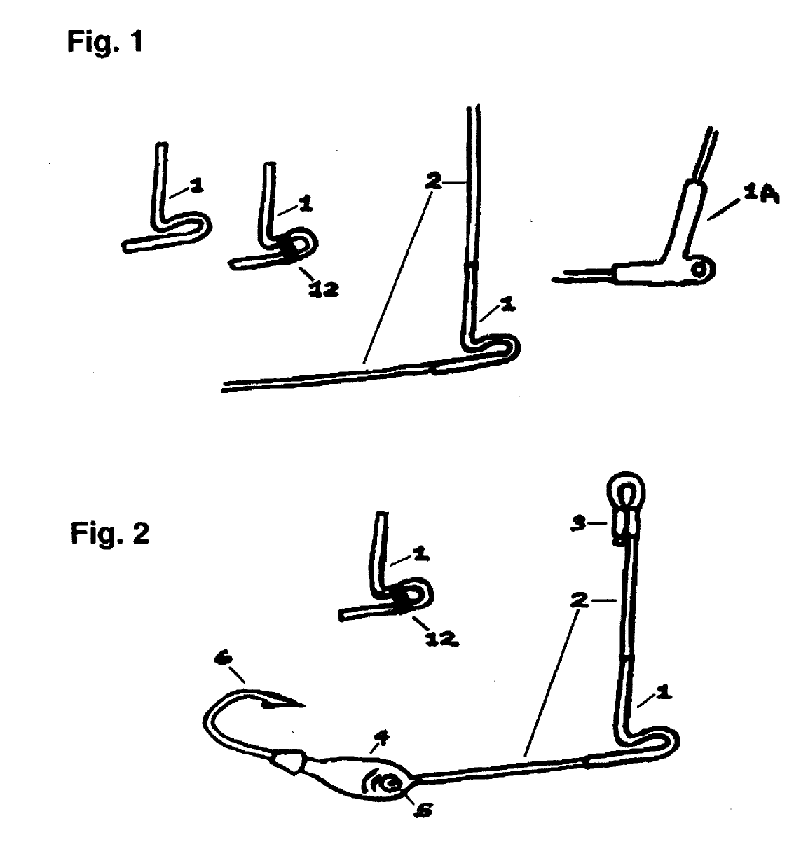

Referring to FIG. 1: The present invention comprises of a main flexible shaft 2, which has a minimum diameter of 0.041 inches and which is made of any material or combination of materials (such a plastic or nylon coated stainless steel wire) which allows for the desired flexibility of the shaft and its two shanks, onto which is incorporated a “V” shape stabilizer 1 or 1A onto which is attached the fishing line. The main flexible shaft can be of any length, depending on the usage needs or requirements, which depend mainly on the type of fish being fished and the fishing conditions (for example, rapids, calm lakes, etc.). Depending on the desired configuration, the angle at which the “V” shape stabilizer 1 or 1A is bent or molded or formed into allows for the flexible main shaft 2 to remain bent into a “V” shape at an angle of between approximately 45 and 120 degrees, and allows the entire assembly to generally maintain the desired “V” shape both in its relaxed position and while the lure assembly is being pulled through water. The tubing used to create the “V” shape stabilizer 1 is made of any material or combination of materials (for example, brass, plastic or carbon fiber resin) which is rigid enough to assure that the main flexible shaft 2, with its two corresponding shanks, retains its desired “V” shape, and which is malleable enough to be bent into a “V” shape 1, which includes the desired partially open eyelet onto which the fishing line is attached, and crimped or clamped into the desired position along the main flexible shaft 2. The tubing used to form the “V” shape stabilizer 1 is slid onto the main flexible shaft 2 and positioned at a desired point along the main flexible shaft, and then, with the appropriate tools, the tube is bent to its desired shape 1 and crimped or clamped into position. The “V” shape stabilizer 1A is made of any material or combination of materials (for example, plastic, carbon fiber, bismuth, etc.) which allow the “V” shape stabilizer 1A, which is designed with an eyelet onto which the fishing line is attached, to be molded or formed directly onto the desired location along the main flexible shaft 2. The material or combination of materials used to form the “V” shape stabilizer 1 or 1A are also selected such that the assembly achieves the desired level of floatability when being pulled through water. Depending on the desired usage of the spinnerbait, which often depends of the type of fish desired to attract (for example, some types of fish tend to stay nearer the bottom of a lake and others tend to remain closer to the surface), the combination of the weight and density of the material or combination of materials used to form the “V” shape stabilizer 1 or 1A will in part determine the degree of floatability of the assembly in water. The main flexible shaft 2 can be of any diameter greater or equal to 0.041 inches and the tubing used for forming the “V” shape stabilizer 1 has a slightly larger inside diameter relative to the diameter of the main flexible shaft 2 such that the main flexible shaft 2 can slide freely yet snugly through the tubing before forming and clamping or crimping. Depending on fishing requirements and depending on the desired size and configuration of the assembly, the main flexible shaft 2 and the tube used to form the “V” shape stabilizer 1 can vary in length, color or combination of colors suited for attracting different varieties of fish in varying fishing conditions. Wound thread, with or without glue or varnish, or a shrinkable tubing ring 12 with or without glue, or any equivalent or similar method of attachment is added to the “V” shape stabilizer 1 in order to close the partially open eyelet and thus better secure the fishing line to the spinnerbait assembly.

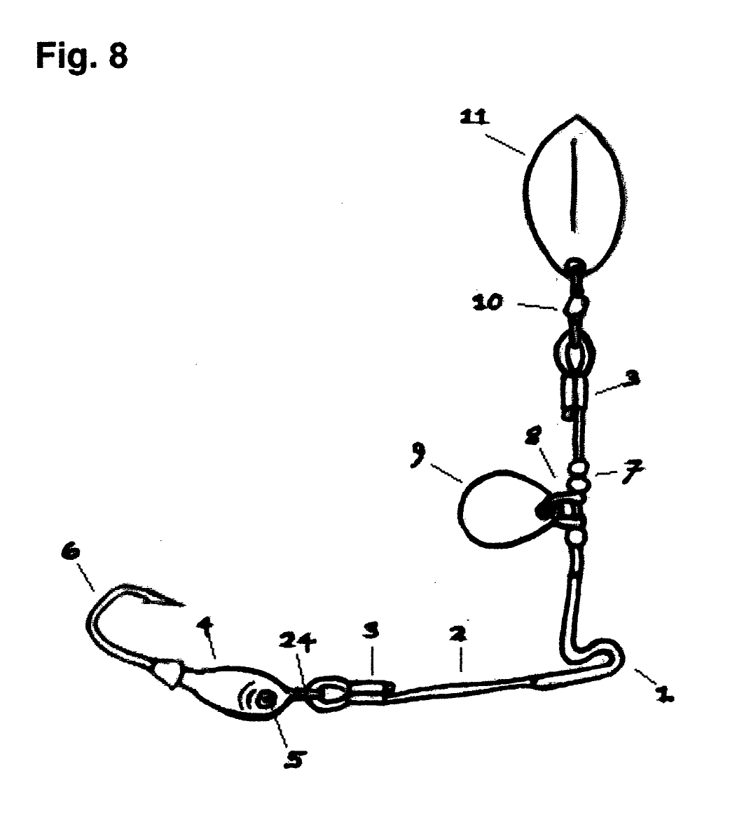

Referring to FIG. 2: FIG. 2 shows the preferred basic embodiment of the spinnerbait assembly where the fish attracting head shape weight 4 with 2-D or 3-D eyes 5 and integrated hook 6 is molded directly onto one extremity of the main flexible shaft 2. In all configurations of the assembly, even when the fish attracting head shape weight 4 with 2-D or 3-D eyes 5, with or without an integrated hook 6 is attached to the same extremity of the main flexible shaft 2 by different means (such as in FIGS. 8, 9, 10 and 11), the opposing extremity of the main flexible shaft 2 is bent into a loop and crimped or clamped into position with a single or double barrel sleeve 3.

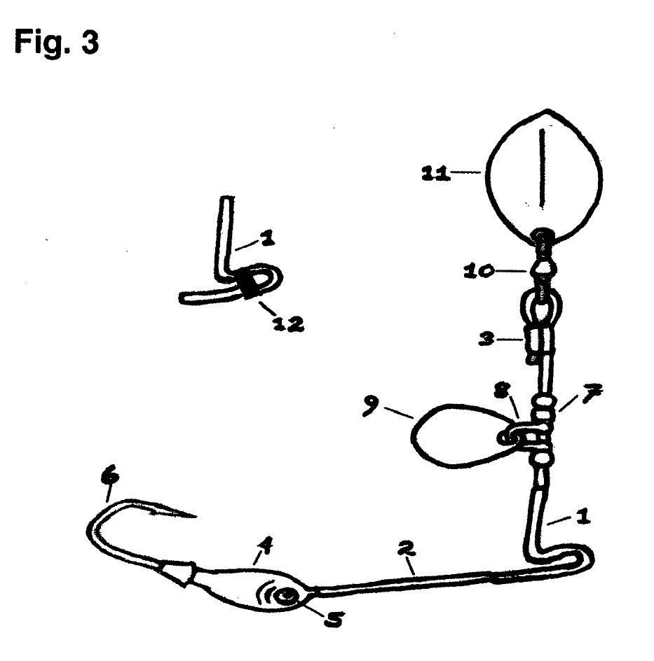

Referring to FIG. 3: Prior to bending that extremity of the main flexible shaft 2 into a loop and securing it with the single or double barrel sleeve 3, beads 7 and a clevis 8 with a blade 9 are incorporated to this shank of the main flexible shaft 2 by sliding them over the main flexible shaft 2 and a blade 11 or a set of blades is attached to the loop by coupling with a crane swivel 10, barrel swivel 10 or ball bearing swivel 10. Although usually made of metal for fishing lure applications, the blades 9 and 11, the clevis 8, and the single or double barrel sleeve 3 and the swivel 10, as well as the beads 7, could be made of any other material or combination of materials that duplicate the desired use and efficiency of the these components. All aforementioned components can be of varying sizes, shapes and colors, and can be color combined as desired for attracting different varieties of fish in varying fishing conditions.

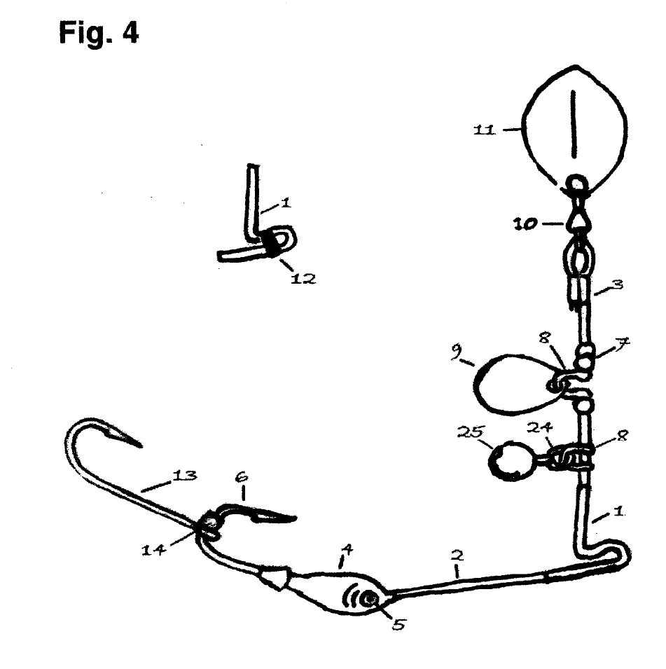

Referring to FIG. 4: A trailer hook 13 is added to the assembly by attaching it to the integrated hook 6 protruding from the fish attracting head shape weight 4 with 2-D or 3-D eyes 5 and securing it in place with a shrinkable tubing ring hook keeper 14 with or without glue such that the trailer hook has freedom of movement but does not fall off. This feature adds to the fish attracting qualities (additional movement) of the assembly. A jingle bell 25, which attracts certain types of fish, is attached to a clevis 8 with a split ring 24, which in turn is attached to the main flexible shaft prior to creating the loop which is held in position with a single or double barrel sleeve 3.

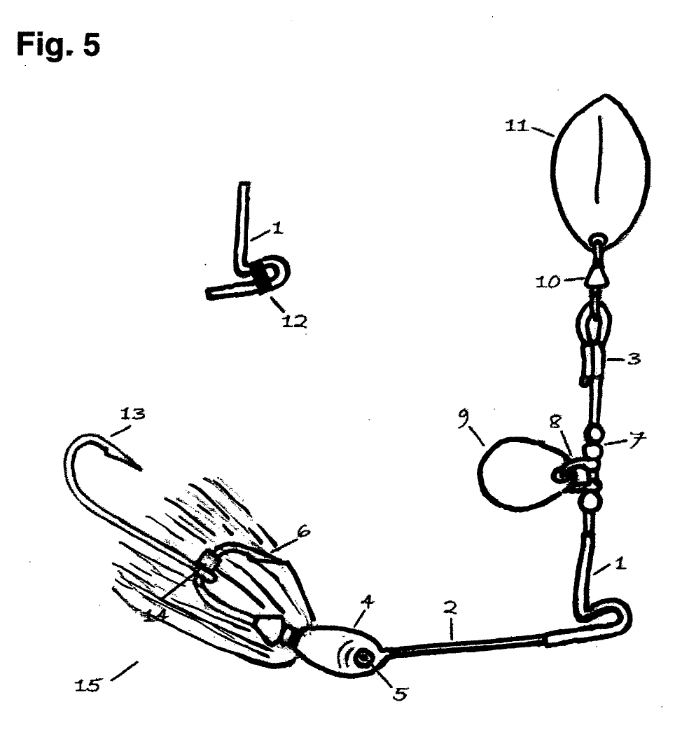

Referring to FIG. 5: FIG. 5 is similar to FIG. 4, but with two differences: 1) the jingle bell 25, the clevis 8 onto which the jingle bell 25 is attached, and the split ring 24 which joins the jingle bell 25 to the clevis 8 are removed, and 2) a hook skirt 15 (another fish attracting component) is added to the assembly near the base of the fish attracting head shape weight 4 with 2-D or 3-D eyes 5 nearest the integrated hook 6 by a variety of means depending on the type of hook skirt 15 used.

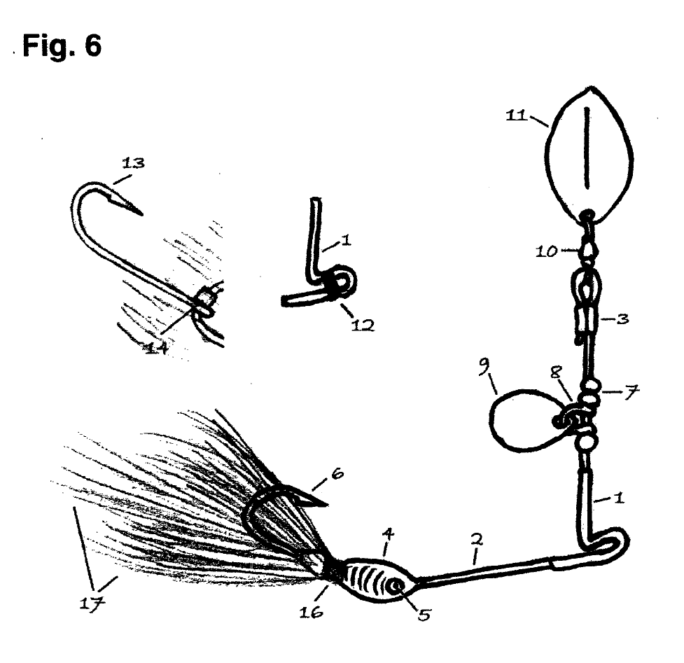

Referring to FIG. 6: FIG. 6 depicts essentially the same assembly as seen in FIG. 5, with or without the trailer hook 13, but with buck tail 17 (another fish attracting component) added to the assembly by tying it with tying thread 16 near the base of the fish attracting head shape weight 4 with 2-D or 3-D eyes 5 nearest the integrated hook 6. Varnish or glue is applied to the thread to further secure it in place.

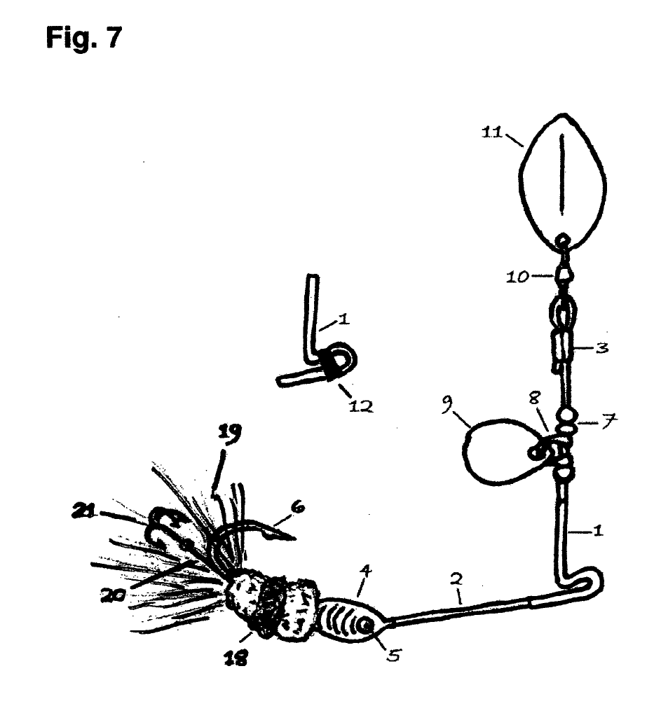

Referring to FIG. 7: FIG. 7 depicts essentially the same assembly as FIG. 3 but incorporates an artificial bumble bee assembly which is set onto the hook 6 by inserting the hook 6 through the bumble bee assembly. The bumble bee assembly, which comprises the bumble bee body 18, hackle 19, trolling wire 20 and a treble hook 21, can be assembled separately, and then inserted onto the hook 6, or it can be assembled directly onto the hook 6 and secured with tying thread and/or glue and/or shrinkable rubber tubing.

Referring to FIG. 8: FIG. 8 depicts an assembly similar to that which is depicted in FIG. 3, but with one main difference: The fish attracting head shape weight 4 with 2-D or 3-D eyes 5 with an integrated hook 6 is attached to the main flexible shaft 2 by means of a split ring 24 attached to a second loop formed by crimping or clamping a single or double barrel sleeve 3 on the same extremity of the main flexible shaft 2 where, in all heretofore Figures, the fish attracting head shape weight 4 with 2-D or 3-D eyes 5 is directly molded onto the main flexible shaft 2. This configuration allows for increased movement of the spinnerbait assembly, another additional fish attracting feature.

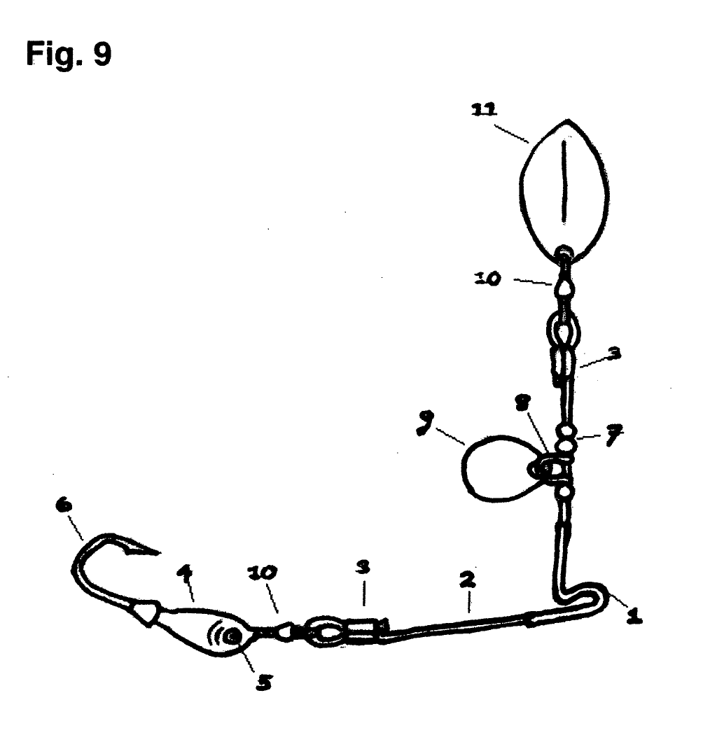

Referring to FIG. 9: FIG. 9 depicts an assembly similar to that which is depicted in FIG. 8, but with one difference: The fish attracting head shape weight 4 with 2-D or 3-D eyes 5 with an integrated hook 6 is attached to the loop of the same extremity of main flexible shaft 2 by means of a crane swivel 10, barrel swivel 10 or ball bearing swivel 10 instead of by means of a split ring 24. As in FIG. 8, this configuration allows for increased movement of the spinnerbait assembly, another additional fish attracting feature.

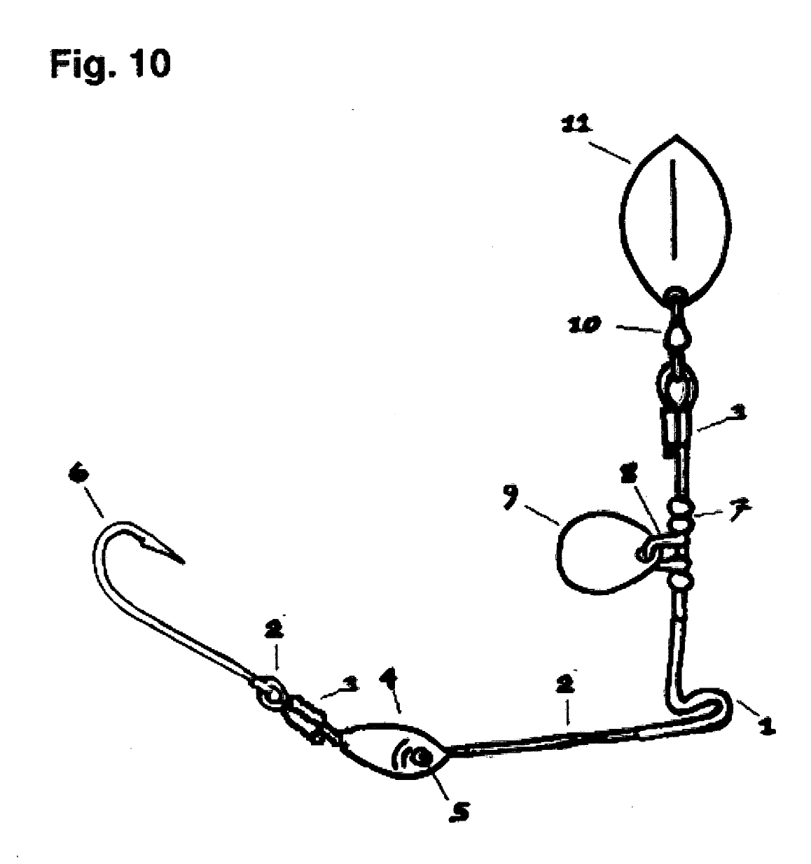

Referring to FIG. 10: FIG. 10 depicts an assembly similar to that depicted in FIG. 9, but where the fish attracting head shape weight 4 with 2-D or 3-D eyes 5, without an integrated hook, is molded directly onto the corresponding shank of the main flexible shaft 2, and a hook 6 is attached to the corresponding loop by clamping the hook 6 directly onto the loop.

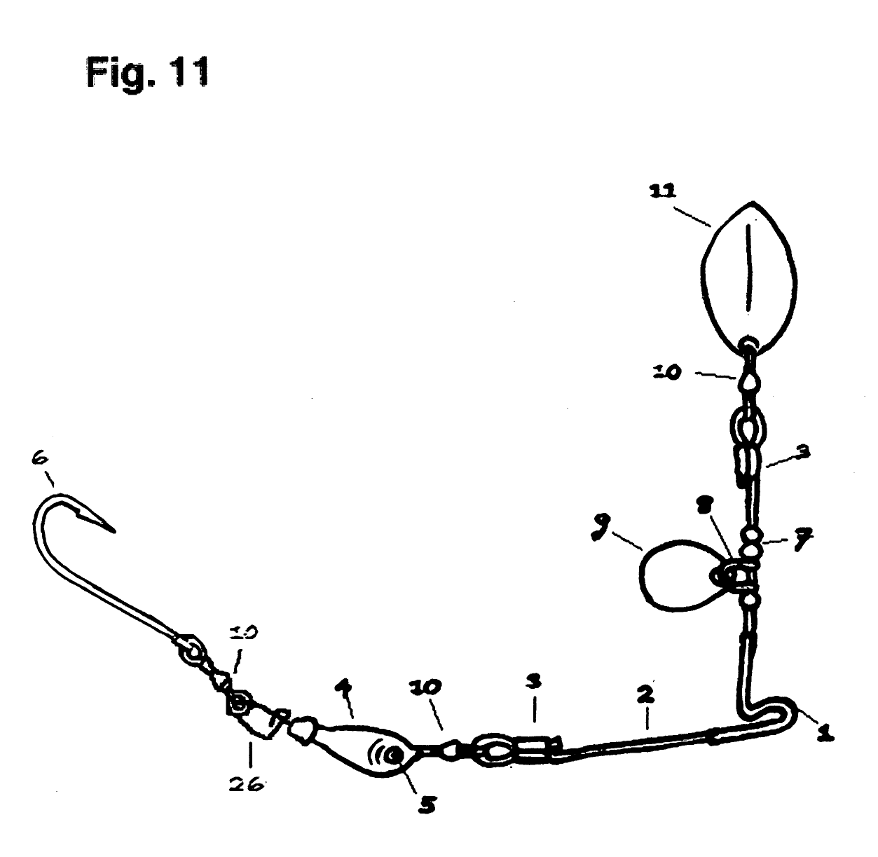

Referring to FIG. 11: FIG. 11 depicts an assembly similar to that depicted in FIG. 9, but in which the fish attracting head shape weight 4 with 2-D or 3-D eyes 5, attached to the main flexible shaft 2 in the same way as depicted in FIG. 9, has integrated onto it a wire clip 26 instead of an integrated hook. The hook 6 is instead attached to the wire clip 26 by means of a crane swivel 10, barrel swivel 10 or ball bearing swivel 10.

What is claimed as being new, innovative and desired to be protected by Letters Patent of the United States is as follows:

1. A flexible spinnerbait fishing lure assembly, comprising a main flexible shaft a) with a minimum diameter of 0.041 inches b) which is made preferably of flexible nylon coated stainless steel wire or any other material or combination of materials which have similar physical properties to flexible nylon coated stainless steel wire c) which can be of any length d) which can be of any color or combinations of colors e) where one or both extremities is bent into a loop of any size and crimped or clamped into position with a single or double barrel sleeve or by any other method achieving the same result.

2. A flexible spinnerbait fishing lure assembly comprising a “V” shape stabilizer angled at between 45 and 120 degrees with an incorporated closed or partially open eyelet onto which to attach a fishing line, which is incorporated onto and over the main flexible shaft along its length, and is preferably made of a) formed tubing having an inside diameter greater than that of the main flexible shaft of the assembly and being of any length or thickness and made preferably of brass or any material or combination of materials with similar physical properties to that of brass, and that can be of any color or combination of colors, and whose incorporated partially open eyelet is formed by bending or forming and preferably closed by winding thread, with or without glue or varnish, or by adding a piece of shrinkable tubing ring or rubber or by any other similar means and materials, with or without glue, to effectively close the partially open eyelet, or b) molded plastic or any combination of materials that can be molded like plastic directly onto the main flexible shaft along its length and which can be of any thickness, length or color or combination of color.

3. A flexible spinnerbait fishing lure assembly according to claims 1 and 2, wherein once the “V” shape stabilizer is incorporated onto the main flexible shaft, the continuous main flexible shaft remains bent in a “V” shape, creating two shanks of the main flexible shaft, each of which can be of varying lengths depending on the positioning of the “V” shape stabilizer, onto which in the vicinity of the extremity of one of the shanks is incorporated by a variety of methods and of any shape, color, material, weight or size, preferably one or more a) fish attracting head shape weights with 2-D or 3-D eyes b) hooks c) trailer hooks d) hook skirts e) other fish attracting attire such as buck tail or bumble bee assemblies, and, onto which in the vicinity of the extremity of the opposite shank and along that shank itself is incorporated, of any shape, color, material, weight or size, and in a variety of configurations and by a variety of methods, preferably one or more f) annular beads g) clevises h) jingle bells i) crane swivels, barrel swivels or ball bearing swivels j) blades k) or other fish attracting components.
